(19) United States
(12) Patent Application Publication
(10) Pub. No.: US 2014/0112270 A1
(43) Pub. Date: Apr. 24, 2014

(54) METHOD AND APPARATUS FOR DIRECT DEVICE TO DEVICE COMMUNICATION IN A WIRELESS COMMUNICATION SYSTEM

(71) Applicant: INNOVATIVE SONIC CORPORATION, Taipei City (TW)

(72) Inventor: Richard Lee-Chee Kuo, Taipei City (TW)

(73) Assignee: INNOVATIVE SONIC CORPORATION, Taipei City (TW)

(21) Appl. No.: 14/057,493

(22) Filed: Oct. 18, 2013

Related U.S. Application Data
(60) Provisional application No. 61/716,747, filed on Oct. 22, 2012.

(51) Int. Cl. H04W 76/02

(52) U.S. Cl. CPC H04W 76/023
USPC 370/329

(57) ABSTRACT

A method and apparatus are disclosed to release a connection for a peer to peer communication session. The method includes initiating, by a first user equipment, a peer to peer communication session with a second user equipment. The method further includes establishing, by the first user equipment, a connection for the peer to peer communication session. The method also includes transmitting, from the first user equipment, information via radio resources allocated to the connection and releasing, by the first user equipment, the connection if there is no traffic over the connection for a specified period of time.

### CROSS-REFERENCE TO RELATED APPLICATIONS

The present application claims the benefit of U.S. Provisional Patent Application Ser. No. 61/716,747 filed on Oct. 22, 2012, the entire disclosure of which is incorporated herein by reference.

### FIELD

This disclosure generally relates to wireless communication networks, and more particularly, to methods and apparatuses for direct device to device communication in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure for which standardization is currently taking place is an Evolved Universal Terrestrial Radio Access Network (E-UTRAN). The E-UTRAN system can provide high data throughput in order to realize the above-noted voice over IP and multimedia services. The E-UTRAN system's standardization work is currently being performed by the 3GPP standards organization. Accordingly, changes to the current body of 3GPP standard are currently being submitted and considered to evolve and finalize the 3GPP standard.

### SUMMARY

A method and apparatus are disclosed to release a connection for a peer to peer communication session. The method includes initiating, by a first user equipment, a peer to peer communication session by a first user equipment with a second user equipment. The method further includes establishing, by the first user equipment, a connection for the peer to peer communication session by the first user equipment. The method also includes transmitting, from the first user equipment, information by the first user equipment via radio resources allocated to the connection. In addition, the method includes releasing, by the first user equipment, the connection if there is no traffic over the connection for a specified period of time.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a flow diagram of a data path for device to device communication according to 3GPP TR 22.803-100.

FIG. 6 is a flow diagram of a data path for device to device communication according to 3GPP TR 22.803-100.

FIG. 7 is flow diagram of a data path for device to device communication according to 3GPP TR 22.803-100.

FIG. 8 is a message sequence chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, or some other modulation techniques.

In particular, the exemplary wireless communication systems devices described below may be designed to support one or more standards such as the standard offered by a consortium named “3rd Generation Partnership Project” referred to herein as 3GPP, including Document Nos. SP-110638, “WID on Proposal for a study on Proximity-based Services”; TR 22.803-100, “Feasibility Study for Proximity Services (ProSe)”; White paper, “FlashLinQ: A Synchronous Distributed Scheduler for Peer-to-Peer Ad Hoc Networks”, 23107-b00; “Quality of Service (QoS) concept and architecture”; and TS24.008-b40, “Core network protocols.” The standards and documents listed above are hereby expressly incorporated herein.

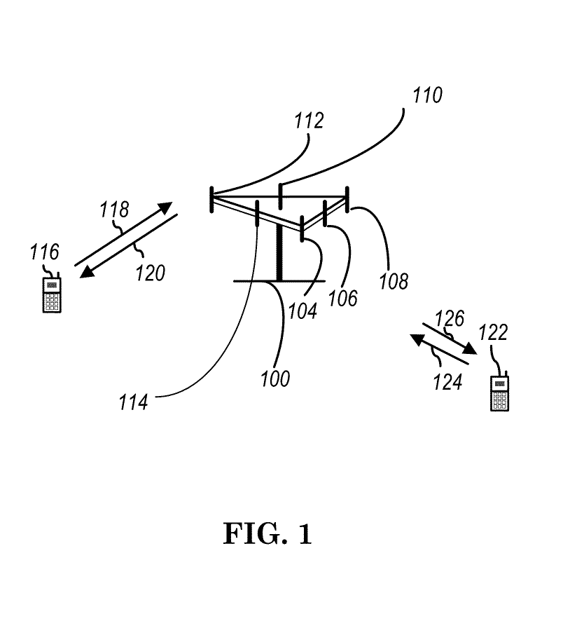

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an eNodeB, or some other terminology. An access terminal (AT) may also be called user equipment (UE), a wireless communication device, terminal, access terminal or some other terminology.

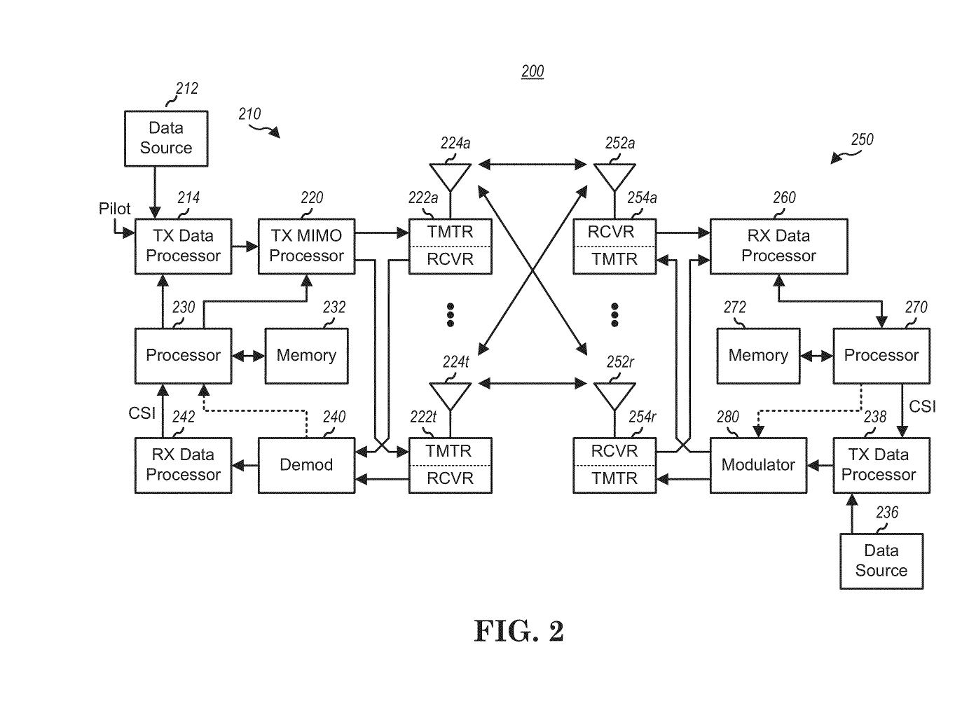

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

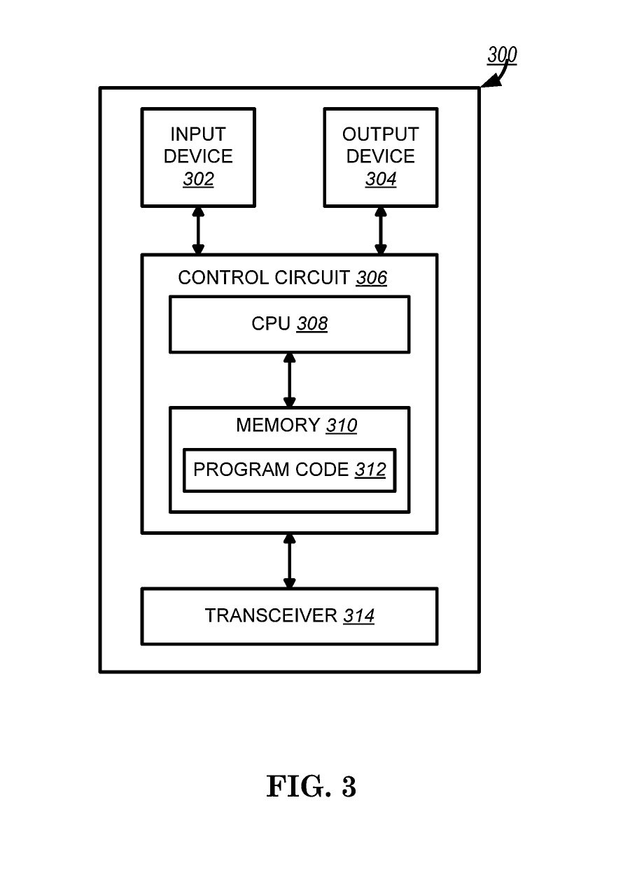

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the LTE system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

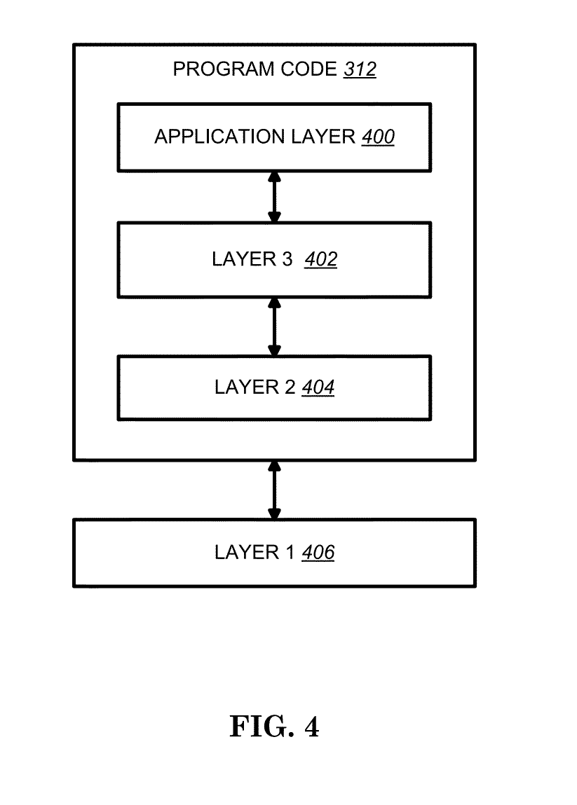

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE or LTE-A systems, the Layer 2 portion may include a Radio Link Control (RLC) layer and a Medium Access Control (MAC) layer. The Layer 3 portion may include a Radio Resource Control (RRC) layer.

3GPP SP-110638 proposes a new study on proximity-based services (ProSe). The justification and objective of this study are as follows:

### 3 Justification

Proximity-based applications and services represent a recent and enormous socio-technological trend. The principle of these applications is to discover instances of the applications running in devices that are within proximity of each other, and ultimately also exchange application-related data. In parallel, there is interest in proximity-based discovery and communications in the public safety community.
Current 3GPP specification are only partially suited for such needs, since all such traffic and signalling would have to be routed in the network, thus impacting their performance and adding un-necessary load in the network. These current limitations are also an obstacle to the creation of even more advanced proximity-based applications.
In this context, 3GPP technology, has the opportunity to become the platform of choice to enable proximity-based discovery and communication between devices, and promote a vast array of future and more advanced proximity-based applications.

### 4 Objective

The objective is to study use cases and identify potential requirements for an operator network controlled discovery and communications between devices that are in proximity, under continuous network control, and are under a 3GPP network coverage, for:
1. Commercial/social use
2. Network offloading
3. Public Safety
4. Integration of current infrastructure services, to assure the consistency of the user experience including reachability and mobility aspects
   Additionally, the study item will study use cases and identify potential requirements for
5. Public Safety, in case of absence of EUTRAN coverage (subject to regional regulation and operator policy, and limited to specific public-safety designated frequency bands and terminals)
   Use cases and service requirements will be studied including network operator control, authentication, authorization, accounting and regulatory aspects.
   The study does not apply to GERAN or UTRAN.

In 3GPP TR 22.803-100, the feasibility study for proximity-based services (ProSe) was discussed, in which a ProSe discovery was defined as containing an open [ProSe] discovery and a restricted [ProSe] discovery. More specifically, these terms are defined in 3GPP as follows:

### 3.1 Definitions

ProSe Discovery: a process that identifies that a UE is in proximity of another, using E-UTRA.
Open [ProSe] Discovery: is ProSe Discovery without explicit permission from the UE being discovered.
Restricted [ProSe] Discovery: is ProSe Discovery that only takes place with explicit permission from the UE being discovered.

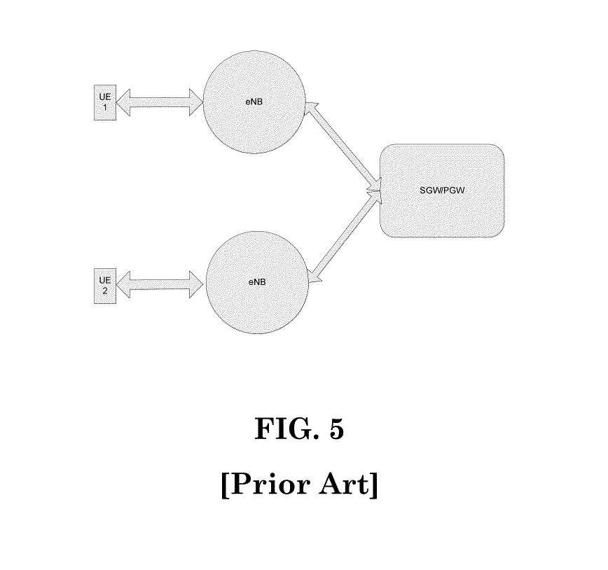

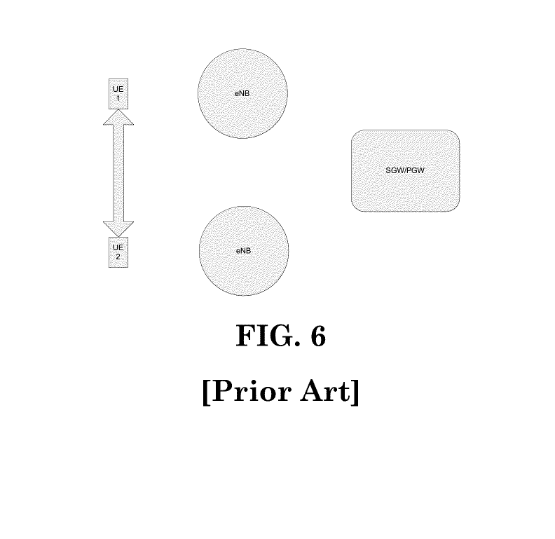

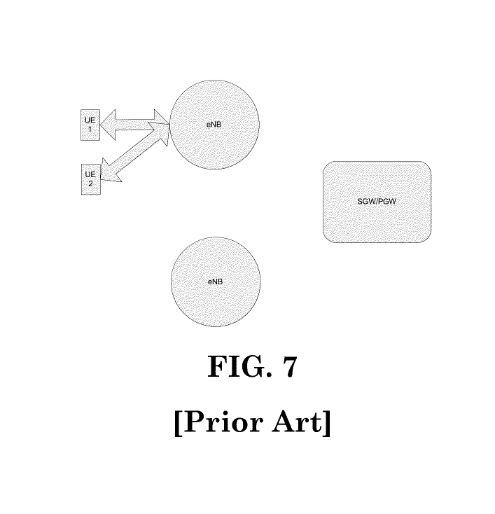

FIGS. 5-7 are directed to different data paths for device to device communication. FIG. 5 illustrates the default data path setup in the Enhanced Packet System (EPS). FIG. 6 illustrates the “direct mode” data path in the EPS for communication between two UEs. It is noted that two eNBs are shown in FIG. 6 for illustration. FIG. 7 illustrates a “locally-routed” data path in the EPS for communication between two UEs when UEs are served by the same eNBs. In 3GPP TR 22.803-100, three kinds of data paths for device to device communication are defined as follows:

### 4.1 Data Paths for ProSe Communications

### Default Data Path Scenario:

Currently, when two UEs in close proximity communicate with each other, their data path (user plane) goes via the operator network. The typical data path for this type of communication is shown in FIG. 5, where eNB(s) and/or GW(s) are involved. FIG. 5 illustrates the default data path setup in the [Enhanced Packet System] EPS.

### ProSe Communication Scenario:

If UEs are in proximity of each other, they may be able to use a local or direct path.
For example, in 3GPP LTE spectrum, the operator can move the data path (user plane) off the access and core networks onto direct links between the UEs. This direct data path is shown in FIG. 6. FIG. 6 illustrates the “direct mode” data path in the EPS for communication between two UEs. It is noted that two eNBs are shown in FIG. 6 for illustration.
Another example is when the data path is locally routed via the eNB(s). This locally-routed data path is shown in FIG. 7. FIG. 7 illustrates a “locally-routed” data path in the EPS for communication between two UEs when UEs are served by the same eNBs.

3GPP TR 22.803-100 also describes a use case for service continuity between infrastructure and E-UTRA ProSe communication paths as follows:

### 5.1.6 Service Continuity Between Infrastructure and E-UTRA ProSe Communication Paths

### 5.1.6.1 Description

### 5.1.6.2 Pre-Conditions

An operator offers a service which makes use of the ProSe feature, in which:
The operator is able to establish a new user traffic session using E-UTRA ProSe communication;
The operator is able to switch user traffic from an infrastructure communication path to an E-UTRA ProSe communication path.
   In addition to that, the following assumptions are made:
Mary and Peter use ProSe-enabled UEs;
Mary and Peter are subscribed to the same cellular operator;
Mary and Peter are currently residing on their HPLMN;
Mary and Peter are subscribed to an operator service that allows them to use ProSe.

### 5.1.6.3 Service Flows

Mary and Peter are engaged in a data session (including one or more flows) that is being routed over the MNO's core network infrastructure.
As Peter moves within proximity of Mary, one or more flows of the data session is switched to an E-UTRA ProSe communication path.
At some point later, the data session is switched back to the infrastructure path.
The user experience is such that the switching of the data path is not perceived by the users.
The user experience of the ongoing user traffic sessions is such that the not switched data flows are not negatively impacted by the switching of other data flows.

### 5.1.6.4 Post-Conditions

### None

### 5.1.6.5 Potential Requirements

### Requirements for E-UTRA ProSe Communications

The system shall be capable of establishing a new user traffic session with an E-UTRA ProSe Communication path, and maintaining both of the E-UTRA ProSe Communication path and the infrastructure path simultaneously, when the UEs are determined to be in range allowing ProSe Communication.

Note: ProSe specifications should take into account the relative speed of ProSe-enabled UEs.

The system shall be capable of moving a user traffic session from the infrastructure path to an E-UTRA ProSe Communication path, when the ProSe-enabled UEs are determined to be in range allowing ProSe Communication.
The system shall be capable of monitoring the communication characteristics (e.g. channel condition, QoS of the path, volume of the traffic etc.) on the E-UTRA ProSe communication path, regardless of whether there is data transferred via infrastructure path.
The system shall be capable of moving a user traffic session from an E-UTRA ProSe communication path to an infrastructure path. At a minimum, this functionality shall support the case when the E-UTRA ProSe Communication path is no longer feasible.
The user shall not perceive the switching of user traffic sessions between the E-UTRA ProSe Communication and infrastructure paths.
The system shall be capable of switching each flow it is aware of between the E-UTRA ProSe Communication and the infrastructure paths, independently.
The establishment of a user traffic session on the E-UTRA ProSe Communication path and the switching of user traffic between an E-UTRA Prose Communication path and an infrastructure path are under control of the network.
The Radio Access Network shall control the radio resources associated with the E-UTRA ProSe Communication path.
The ProSe mechanism shall allow the operator to change the communication path of a user traffic session without affecting the QoS of the session.
The ProSe mechanism shall allow the operator to change the communication path of one user traffic session of a UE without affecting the communication paths of other ongoing user traffic sessions.
The ProSe mechanism shall allow the operator to change the communication path of a user traffic session according to decisions based upon the QoS requirements of the session and the QoS requirements of other ongoing sessions.
The system shall be capable of selecting the most appropriate communications path, according to operator preferences. The criteria for evaluation may include the following, although not restricted to:
System-specific conditions: backhaul link, supporting links or core node (EPC) performance;
Cell-specific conditions: cell loading;
UE to UE conditions: communication range, channel conditions and achievable QoS;
UE to eNB conditions: communication range, channel conditions and achievable QoS;
Service-type conditions: APN, service discriminator.

When a socio-networking application notifies a user of discovering a friend in its proximity, the user may initiate a peer to peer communication session with this friend via the application. In the prior art, such as U.S. Patent Application Publication Nos. 20090232142 and 20120147745, some methods for realizing the peer to peer discovery and communication are disclosed.

For example, U.S. Patent Application Publication No. 20090232142 (“the '142 application”) discloses how a wireless terminal establishes a peer-to-peer connection with another wireless terminal via paging signaling on the paging channel. According to the '142 application, the peer parties may establish a connection for a peer to peer communication session and one or more connection identifiers (CIDs) may be associated with the connection. The number of CIDs associated with a specific connection may vary over time, depending on the traffic. Since resource scheduling is done per CID, more CIDs imply more chances to gain radio resources for traffic transfer. In addition, the '142 application discloses that the peer parties of a connection negotiate the CID(s) for this connection via paging signaling during a paging interval. The paging interval contains a quick paging channel, a CID broadcast channel, a full paging channel, and a paging ACK channel.

For example, U.S. Patent Application Publication No. 20120147745 (“the '745 application”) discloses how peer wireless terminals gain a connection identifier (CID) via monitoring the CID broadcast channel and gain resources for data transfer via transmitting & receiving signals on the connection scheduling channel. The '745 application discusses the CID broadcast channel, which provides (1) a distributed protocol for CID allocations for new connections, (2) a mechanism for CID collision detection, and (3) evidence to a UE that its link connection with a communication peer still exists. These imply all currently existing CIDs should be broadcast on the CID broadcast channel so that peer parties of a new connection can monitor the CID broadcast channel and select un-occupied CID(s) for this new connection. In other words, once a CID is allocated to a connection, it should be broadcast on the CID broadcast channel periodically until the associated connection is released. Besides, according to a white paper [5], FlashLinQ is designed to be a synchronous 5 MHz peer-to-peer system and supports a maximum CID number of 112.

After acquiring a CID, either party of a connection may signal its transmit request at the resources associated with the CID during the connection scheduling channel if it has information for transmission. Information may then be transmitted on the data segment channel if this CID gains the resources.

However, the '142 and '745 applications do not disclose when a connection will be released. Typically, a connection will be released when the communication session is ended by the user or application who initiates the session—just like a voice call session.

A data transfer session of a socio-networking application usually may last for a long time, especially if a user is dealing with other stuff at the same time while chatting with a friend via messaging. In this situation, the traffic bursts only occur occasionally. Thus, it is not efficient in terms of resource usage for a connection to occupy a CID during the whole data transfer session because a new connection cannot gain resources for transmission without owning a valid CID. Therefore, it should be beneficial for a UE to release its CID/connection at a proper time so that more UEs can share the same radio resources.

According to one exemplary method, a UE engaging in a data transfer session does not signal presence of the current CID on the CID broadcast channel if the transmit buffer for this data transfer session is empty. The UE may further consider the current CID/connection as released if the peer party does not signal presence of the current CID on the CID broadcast channel either. The peer parties may try to re-acquire a new CID/connection for this data transfer session during a new paging interval if there is new data for transfer.

According to one alternative embodiment, the current CID/connection is released when the UE detects that there is no traffic over the current connection for a specified period of time. Alternatively, the UE may determine whether there is traffic from the other party by monitoring the connection scheduling channel.

It is possible that the UE may not be able to quickly re-acquire a new CID for the current session when new traffic arrives, which will cause delay to the following traffic. This delay may be tolerable to a data transfer session. However, this delay may not be acceptable to a voice transfer session because of its strict QoS requirement. Thus, in yet another alternative embodiment, the traffic class of the peer to peer communication session is taken into consideration for CID/connection release. For example, according to one exemplary method, the UE may release the current CID/connection if the traffic class is interactive class or background class. The UE should not release the current CID/connection if the traffic class is conversational class or streaming class. It is noted that these four (4) traffic classes (i.e., conversational class, streaming class, interactive class, and background class) are defined in 3GPP TS23.107 and used in an Activate PDP Context Request message specified in 3GPP TS24.008.

Although the above ideas are described with respect to one CID, they may also be applied to a situation where multiple CIDs are associated with one connection.

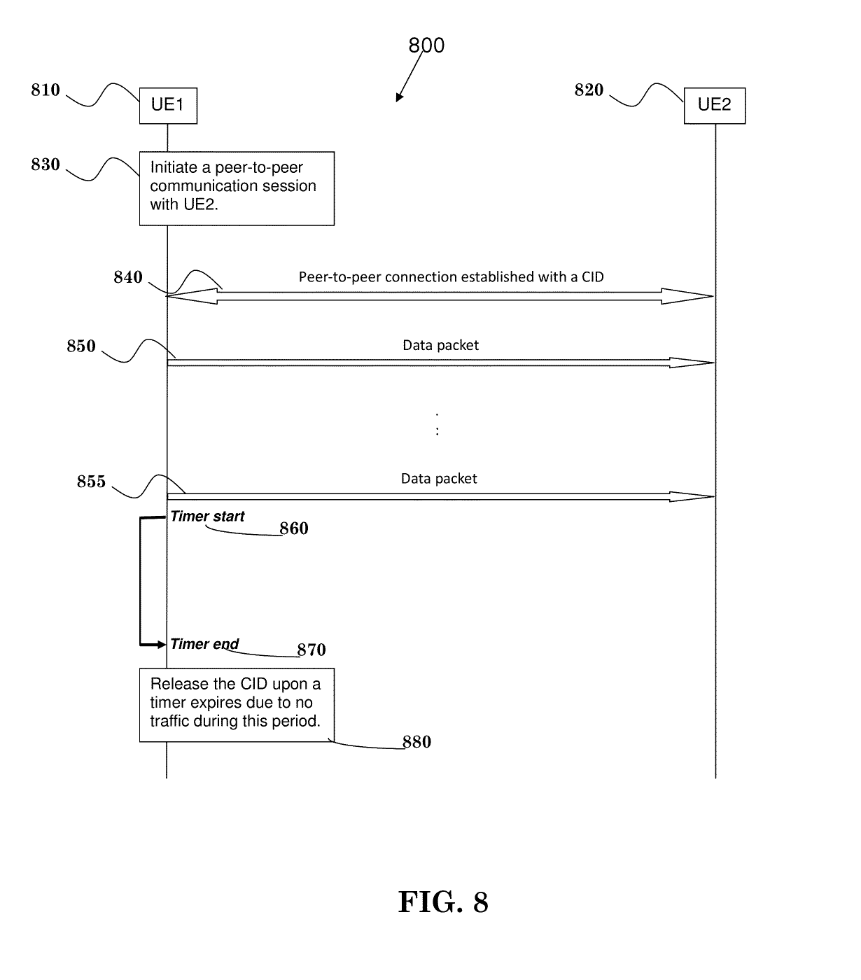

FIG. 8 is a message sequence chart 800 according to one exemplary embodiment. As shown in FIG. 8, in step 830, a first UE 810 initiates a peer-to-peer communication session with a second UE 820. In step 840, a peer to peer connection is established with a CID between the first UE and the second UE. In steps 850 and 855, the first UE 810 transmits data packets to the second UE 820. After the data packets have been transmitted, a timer is started in step 860 and is ended in step 870. In step 880, the first UE 810 releases the CID/connection after the timer expires because there is no traffic over the connection when the timer was running.

In one embodiment, the first UE may determine whether there is traffic from the second UE by monitoring a connection scheduling channel. Furthermore, the traffic class of the peer to peer communication session is an interactive class or a background class. In addition, the data path of the peer to peer communication session goes directly between the first UE and the second UE without via a network node (e.g., eNB—“evolved Node B”).

In one embodiment, the connection identifier (CID) of the connection is determined by monitoring the CID broadcast channel and negotiating via paging signaling. Furthermore, whether the connection gains radio resources for transmission is determined according to signals transmitted on the connection scheduling channel by all UEs which are currently engaged in peer to peer communication sessions. In addition, the first or second UE would transmit a signal at radio resources corresponding to its CID on the connection scheduling channel. Alternatively, the first or second UE would transmit a signal at radio resources corresponding to the CID on the CID broadcast channel to signal the presence of the CID. Also, allocation of radio resources to the connection for transmission may not be performed by a network node (e.e., eNB).

In one embodiment, the first UE determines whether to release the connection based on a traffic class or QoS of the peer to peer communication session if there is no traffic over the connection for a specified period of time. Furthermore, the first UE would release the connection if the traffic class of the peer to peer communication session is an interactive class of a background class. However, the first UE would not release the connection if the traffic class of the peer to peer communication session is a conversational class or a streaming class.

Referring back to FIGS. 3 and 4, the device 300 includes a program code 312 stored in memory 310. In one embodiment, the CPU 308 could execute the program code 312 (i) to initiate, by a first user equipment, a peer to peer communication session with a second user equipment, (ii) to establish, by the first user equipment, a connection for the peer to peer communication session, (iii) to transmit, from the first user equipment, information via radio resources allocated to the connection, and (iv) releasing, by the first user equipment, the connection if there is no traffic over the connection for a specified period of time.

In addition, the CPU 308 can execute the program code 312 to perform all of the above-described actions and steps or others described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for releasing a connection for a peer to peer communication session, the method comprising:
initiating, by a first user equipment, a peer to peer communication session with a second user equipment;
establishing, by the first user equipment, a connection for the peer to peer communication session;
transmitting, from the first user equipment, information via radio resources allocated to the connection; and
releasing, by the first user equipment, the connection if there is no traffic over the connection for a specified period of time.

2. The method of claim 1, wherein the first user equipment may determine whether there is traffic from the second user equipment by monitoring a connection scheduling channel.

3. The method of claim 1, wherein a traffic class of the peer to peer communication session is an interactive class or a background class.

4. The method of claim 1, wherein a data path of the peer to peer communication session goes directly between the first user equipment and the second user equipment without via a network node.

5. The method of claim 1, wherein a connection identifier (CID) of the connection is determined by monitoring the CID broadcast channel and negotiating via paging signaling with each other.

6. The method of claim 1, wherein whether the connection gains radio resources for transmission is determined according to signals transmitted on the connection scheduling channel by all user equipments which are currently engaged in peer to peer communication sessions.

7. The method of claim 1, wherein the first or second user equipment transmits a signal at radio resources corresponding to its connection identifier (CID) on the connection scheduling channel.

8. The method of claim 1, wherein allocation of radio resources to the connection for transmission is not performed by a network node.

9. The method of claim 1, wherein the first or second user equipment transmits a signal at radio resources corresponding to the connection identifier (CID) on the CID broadcast channel to signal presence of the CID.

10. A method for releasing a connection for a peer to peer communication session, the method comprising:
initiating, by a first user equipment, a peer to peer communication session with a second user equipment;
establishing, by the first user equipment, a connection for the peer to peer communication session;
transmitting, from the first user equipment, information via radio resources allocated to the connection; and
determining, by the first user equipment, whether to release the connection based on a traffic class or QoS of the peer to peer communication session if there is no traffic over the connection for a specified period of time.

11. The method of claim 10, further comprising:
releasing the connection by the first user equipment if the traffic class of the peer to peer communication session is an interactive class or a background class.

12. The method of claim 10, further comprising:
not releasing the connection by the first user equipment if the traffic class of the peer to peer communication session is a conversational class or a streaming class.

13. A communication device for releasing a connection for a peer to peer communication session, the communication device comprising:
a control circuit;
a processor installed in the control circuit;
a memory installed in the control circuit and operatively coupled to the processor;
wherein the processor is configured to execute a program code stored in memory to release a connection for a peer to peer communication session by:
initiating, by a first user equipment, a peer to peer communication session with a second user equipment;
establishing, by the first user equipment, a connection for the peer to peer communication session;
transmitting, from the first user equipment, information via radio resources allocated to the connection; and
releasing, by the first user equipment, the connection if there is no traffic over the connection for a specified period of time.

14. The communication device of claim 13, wherein the first user equipment may determine whether there is traffic from the second user equipment by monitoring a connection scheduling channel.

15. The communication device of claim 13, wherein a traffic class of the peer to peer communication session is an interactive class or a background class.

16. The communication device of claim 13, wherein a data path of the peer to peer communication session goes directly between the first user equipment and the second user equipment without via a network node.

17. The communication device of claim 13, wherein a connection identifier (CID) of the connection is determined by monitoring the CID broadcast channel and negotiating via paging signaling with each other.

18. The communication device of claim 13, wherein whether the connection gains radio resources for transmission is determined according to signals transmitted on the connection scheduling channel by all user equipments which are currently engaged in peer to peer communication sessions.

19. The communication device of claim 13, wherein the first or second user equipment transmits a signal at radio resources corresponding to its connection identifier (CID) on the connection scheduling channel.

20. The communication device of claim 13, wherein the first or second user equipment transmits a signal at radio resources corresponding to the connection identifier (CID) on the CID broadcast channel to signal presence of the CID.
